(19) United States
(12) Patent Application Publication
(10) Pub. No.: US 2026/0099490 A1
(43) Pub. Date: Apr. 9, 2026

(54) SYSTEM AND METHOD FOR CONVERSION OF TEXT TO STRUCTURED QUERY LANGUAGE

(71) Applicant: THE GOVERNING COUNCIL OF THE UNIVERSITY OF TORONTO, Toronto (CA)

(72) Inventors: Kaiwen CHEN, Toronto (CA); Nikolaos KOUDAS, Toronto (CA); Yueting CHEN, North York (CA); Xiaohui YU, Toronto (CA)

(21) Appl. No.: 19/347,832

(22) Filed: Oct. 2, 2025

Related U.S. Application Data
(60) Provisional application No. 63/702,762, filed on Oct. 3, 2024.

(51) Int. Cl. G06F 16/2452; G06F 16/21

(52) U.S. Cl. CPC G06F 16/24522; G06F 16/211

(57) ABSTRACT

There is provided a system and method for conversion of natural language text to structured query language query. The method including: receiving a natural language question; linking schema to the received natural language question using a machine learning model, the linking of schema including: determining or predicting one or more branching points each representing deviations of generated tokens from ground truth; and performing a corrective action to replace generated tokens at the branching points; generating a structured query language query using a trained large language model, the large language model taking the natural language question and the schema linked to the received natural language question as input; and outputting the structured query language query.

### TECHNICAL FIELD

The following relates generally to database querying, and more particularly, to systems and methods for conversion of text to structured query language.

### BACKGROUND

The advent of large language models (LLMs) has precipitated a paradigm shift in addressing canonical database challenges, encompassing data integration, information retrieval, and query comprehension. These models' sophisticated natural language understanding capabilities facilitate the extraction of structured data from unstructured text with unprecedented semantic fidelity. By leveraging transformer architectures and self-supervised learning on vast corpora, LLMs exhibit remarkable efficacy in discerning complex linguistic patterns and contextual nuances, thereby augmenting traditional database operations with enhanced semantic interpretation. As an example, LLMs can seamlessly integrate disparate data sources, enhance the precision of information retrieval systems, and improve the understanding and processing of complex queries.

LLMs are generally useful for conversion of text to structured query language (SQL); generally referred to as ‘text-to-SQL’. Text-to-SQL encompasses the transformation of natural language queries into corresponding SQL statements, leveraging the underlying structure of relational databases; thus permitting non-technical users, who use natural language, to interact with databases effectively. Text-to-SQL has wide-ranging implications for domains such as interactive data exploration, automated query generation, and natural language interfaces for database systems. However, the task presents several substantial challenges, including the inherent ambiguity of natural languages, the rigid syntactic and semantic constraints of SQL, and the necessity for precise schema mapping and entity resolution within the context of the query.

### SUMMARY

In an aspect, there is provided a computer-implemented method for conversion of natural language text to a structured query language query, the method comprising: receiving a natural language question; linking schema to the received natural language question using a machine learning model, wherein generation of the machine learning model comprises: determining or predicting one or more branching points each representing deviations of generated tokens from ground truth; and performing a corrective action to replace generated tokens at the branching points; generating a structured query language query using a trained large language model, the large language model taking as input the natural language question and the schema linked to the received natural language question; and outputting the structured query language query.

In a particular case of the method, the generated tokens comprise units of text representing strings of data of a database schema element.

In another case of the method, for determination of the one or more branching points, the ground truth comprises ground truth tokens, the ground truth tokens comprising a set of column and table names in the training data that are correct for given text queries in the training data.

In yet another case of the method, the corrective action comprises replacing the generated token with a corresponding correct ground truth token.

In yet another case of the method, prediction of the one or more branching points comprises predicting when each of the generated tokens deviate from a respective correct ground truth token.

In yet another case of the method, predicting when each of the generated tokens deviate from the respective correct ground truth token comprises using one or more classifier models, and wherein generation of the token comprises using the results of the one or more classifier models to quantify the probability that the generated token is a branching point.

In yet another case of the method, the one or more classifier models are provided for each hidden state of the machine learning model.

In yet another case of the method, each classifier model is trained using a training set of hidden state vectors for each generated token in the training set and a corresponding set of boolean variables indicating a ground truth value of whether such token corresponds to a branching point.

In yet another case of the method, generation of the machine learning model further comprises ceasing generation of the model and performing self-correction or soliciting human intervention using table trace back, the table trace back determines a difference between a decoder function computed on a sequence of tokens before and after the branching point.

In yet another case of the method, the corrective action comprises using a surrogate model to confirm relevance of the tables determined from the table trace back to the structured query language query.

In another aspect, there is provided a system for conversion of natural language text to a structured query language query, the system comprising one or more processing units and a data memory, the data memory comprising instructions for the one or more processing units to execute: an input module to receive a natural language question; a schema module to link schema to the received natural language question using a machine learning model, wherein generation of the machine learning model comprises: determining or predicting one or more branching points each representing deviations of generated tokens from ground truth; and performing a corrective action to replace generated tokens at the branching points; a translation module to generate a structured query language query using a trained large language model, the large language model taking as input the natural language question and the schema linked to the received natural language question; and an output module to output the structured query language query.

In a particular case of the system, the generated tokens comprise units of text representing strings of data of a database schema element.

In another case of the system, for determination of the one or more branching points, the ground truth comprises ground truth tokens, the ground truth tokens comprising a set of column and table names in the training data that are correct for given text queries in the training data.

In yet another case of the system, the corrective action comprises replacing the generated token with a corresponding correct ground truth token.

In yet another case of the system, prediction of the one or more branching points by the schema module comprises predicting when each of the generated tokens deviate from a respective correct ground truth token.

In yet another case of the system, predicting when each of the generated tokens deviate from the respective correct ground truth token comprises using one or more classifier models, and wherein generation of the token comprises using the results of the one or more classifier models to quantify the probability that the generated token is a branching point.

In yet another case of the system, the one or more classifier models are provided for each hidden state of the machine learning model.

In yet another case of the system, each classifier model is trained using a training set of hidden state vectors for each generated token in the training set and a corresponding set of boolean variables indicating a ground truth value of whether such token corresponds to a branching point.

In yet another case of the system, generation of the machine learning model by the schema module further comprises ceasing generation of the model and performing self-correction or soliciting human intervention using table trace back, the table trace back determines a difference between a decoder function computed on a sequence of tokens before and after the branching point.

In yet another case of the system, the corrective action comprises using a surrogate model to confirm relevance of the tables determined from the table trace back to the structured query language query.

In another aspect, there is provided a non-transitory computer-readable medium storing instructions that, when executed by one or more processing units, cause the one or more processing units to perform operations comprising: receiving a natural language question; linking schema to the received natural language question using a machine learning model, wherein generation of the machine learning model comprises: determining or predicting one or more branching points each representing deviations of generated tokens from ground truth; and performing a corrective action to replace generated tokens at the branching points; generating a structured query language query using a trained large language model, the large language model taking as input the natural language question and the schema linked to the received natural language question; and outputting the structured query language query.

These and other embodiments are contemplated and described herein. It will be appreciated that the foregoing summary sets out representative aspects of systems and methods to assist skilled readers in understanding the following detailed description.

### BRIEF DESCRIPTION OF THE DRAWINGS

A greater understanding of the embodiments will be had with reference to the figures, in which:

FIG. 1A illustrates an example error-prone query using a BIRD benchmark where there is ambiguity in the query;

FIG. 1B illustrates an example error-prone query using the BIRD benchmark where there is a lack of metadata description at a schema;

FIG. 2 illustrates an example framework using the present embodiments where probable errors are detected during answer generation, and there is abstention from generating the query (left), a user is asked for confirmation of the potential schema (middle), or there is prompting of the user for hints (right);

FIG. 3 is a diagram of a system for conversion of natural language text to structured query language, in accordance with an embodiment;

FIG. 4 is a flowchart of a method for conversion of natural language text to structured query language, in accordance with an embodiment;

FIG. 5A is a chart showing distribution of probability for generation;

FIG. 5B is a chart showing distribution of number of branching points;

FIG. 6 is a diagram showing that during the generation of schema linking tokens, there is a comparison of a predicted token with ground truth;

FIG. 7 is a diagram of an example implementation of a branching point prediction, where calibrated classifiers per layer are trained to predict branching points;

FIG. 8A is a chart showing coverage and extra abstention rate for each error level for table linking conformal multi-layer branching point prediction;

FIG. 8B is a chart showing coverage and extra abstention rate for each error level for column linking conformal multi-layer branching point prediction;

FIG. 9A is a chart showing coverage and extra abstention rate curves for different values of k using random permutation; and

FIG. 9B is a chart showing coverage and extra abstention rate curves for different values of k using majority vote.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine, or device exemplified herein that executes instructions may include or otherwise have access to computer-readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer-readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application, or module herein described may be implemented using computer readable/executable instructions that may be stored or otherwise held by such computer-readable media and executed by the one or more processors.

The following relates generally to database querying, and more particularly, to systems and methods for conversion of text to structured query language.

Conventional approaches for text-to-SQL generally rely on parsing trees and human-crafted rules, which support only subsets of natural language or require user interactions; thus limiting their applications. With advances in deep learning, some approaches utilize pre-trained language models (PLM), such as BERT, Grappa, T5, or approach the problem as a sequence-to-sequence learning task using encoder-decoder architectures. To enforce the grammatical rules of SQL, rather than generating SQL tokens directly, most approaches utilize grammar-based or sketch-based approaches for decoders. However, such approaches require extensive training corpora and the model capabilities may be limited by their sizes and architectures.

LLM-based approaches for text-to-SQL have generally primarily focused on in-context learning settings, utilizing LLMs with prompt engineering techniques. While there is some exploration of prompt design in the zero-shot setting, most of these approaches concentrate on few-shot methods, where a limited number of demonstrations are available in the context as examples. These in-context learning approaches address text-to-SQL from one or more aspects, including question decomposition, demonstration selection, prompt design, and additional procedures such as ranking, self-correction, majority voting, or utilizing execution results. For instance, DIN-SQL proposes to decompose the problem into subtasks, including schema linking, query classification & decomposition, SQL generation, and self-correction, while PURPLE proposes to focus on demonstration selection with four modules consists of schema pruning, skeleton prediction, demonstration selection, and database adaption. Additionally, other approaches have explored applying supervised fine-tuning techniques on LLMs.

Schema linking can be used to increase SQL generation performance and domain generalization. Some approaches for schema linking utilize simple heuristics, such as string matching, to identify columns/tables from natural language; mainly as a pre-processing step that can result in inaccurate linking. To enhance performance, some approaches resolve schema linking either as a separate problem or as a component in a machine learning network; leveraging techniques such as co-attention and graph encoding. In the case of text-to-SQL LLMs, schema linking has been incorporated as a component to include only related database elements, or to prune unrelated ones based on schema ranking for performance improvement.

LLMs have yielded substantial improvements in accuracy and performance for text-to-SQL across various benchmarks, including surpassing previous approaches by over 30% in execution accuracy. There are a number of approaches for improving text-to-SQL conversion, such as prompt engineering, fine-tuning LLMs using extensive SQL example repositories to improve SQL generation accuracy, and improving schema linking. However, a substantial challenge remains due to the lack of ability to quantify and assess the confidence in the SQL queries generated, particularly where LLMs are implemented as opaque processing units. Crucially, such approaches generate outputs to every input received, even when it may not be adequately equipped to do so, due to the lack of domain-specific knowledge or additional contextual information. This often leads to outputs that are essentially educated guesses, which can compromise the accuracy and relevance of the results.

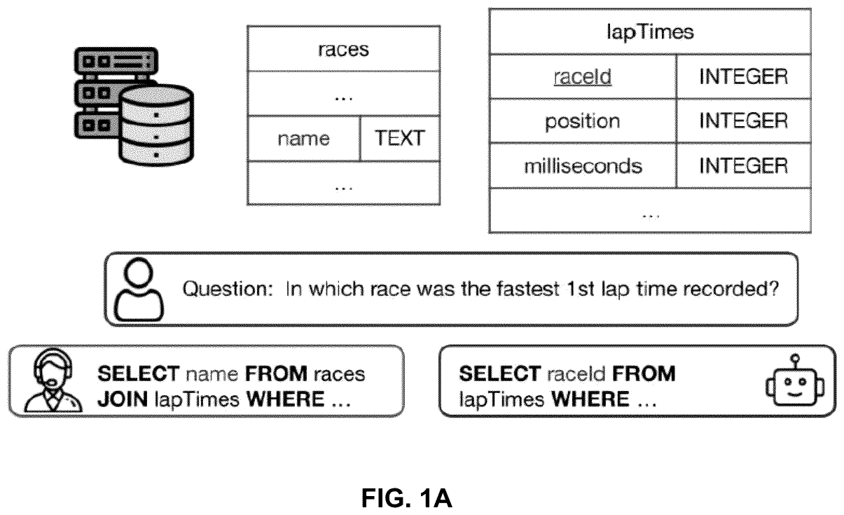

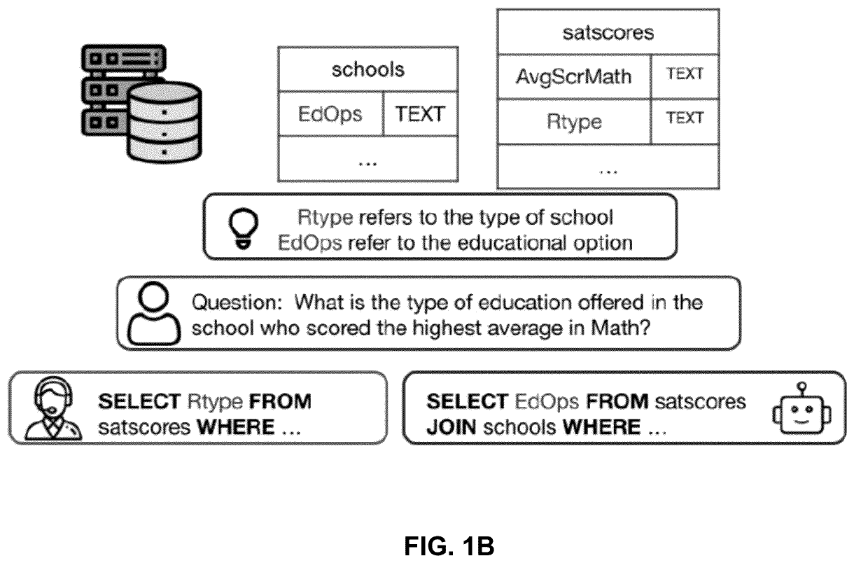

In an example of the above challenge, FIG. 1A illustrates an example query using a benchmark called BIRD (BIg Bench for LaRge-scale Database Grounded Text-to-SQL Evaluation). In this example, the user query seeks to identify the race with the minimum first lap time. The term “race” introduces semantic ambiguity, as it could reference either the race name in the races relation or the raceId in the lapTimes relation. Consequently, while the ground-truth SQL and the model-generated query may yield divergent result sets, both should be considered valid interpretations given the inherent ambiguity in the natural language query. Similarly, consider the scenarios illustrated in FIG. 1B, where the language model makes an erroneous generation not due to semantic ambiguity but simply because the schema does not provide enough information to aid correct generation. In this example, it is unclear whether EdOps or Rtype stands for the type of education, even with the help of the database description.

The issues illustrated by the above examples are particularly relevant in a schema linking phase of query generation. Schema linking involves mapping the natural language components of the query to the corresponding elements in the database schema. This phase is particularly error-prone in text-to-SQL pipelines due to the complexity of accurately resolving entities and aligning them with the correct schema elements.

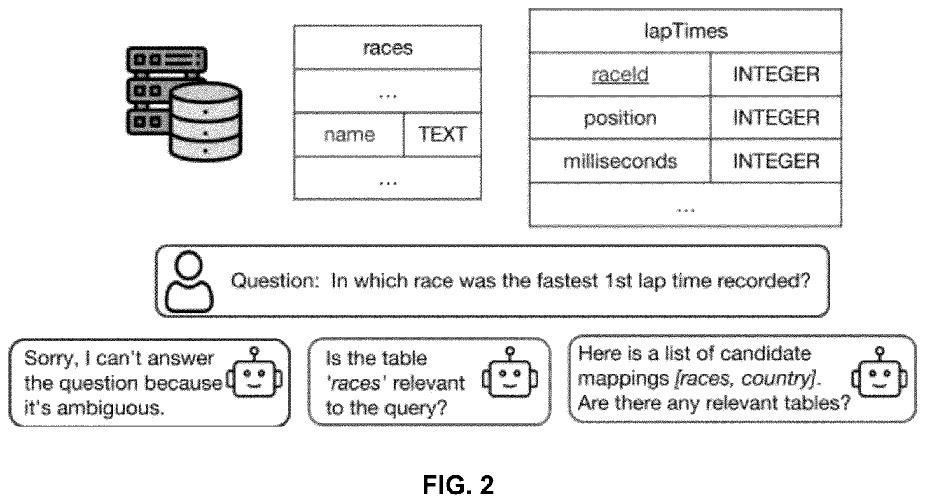

To overcome the substantial challenges in the art, the present embodiments advantageously enhance query generation reliability. Particularly, the present embodiments are able to abstain during the answer-generation process, and instead address the schema linking phase because such phase is the most error-prone and crucial for the overall accuracy of text-to-SQL. FIG. 2 illustrates an example framework using embodiments of the present disclosure. When probable errors are detected during answer generation, a model will either abstain from generating the query (left), ask the user for confirmation of the potential schema (middle), or prompt the user for hints (right). As illustrated in FIG. 2, a framework used by embodiments of the present disclosure can autonomously detect errors during schema linking and react independently. For example, as shown in the leftmost chatbox, when the model detects a probable error during the generation of the answer, automatic mapping can be halted to avoid likely erroneous linking. Alternatively, an interactive refinement can be conducted; which involves presenting a human user with a targeted disambiguation question (middle chatbox) for confirmation, or a list of probable mapping candidates (rightmost chatbox) can be presented to the human user or an expert LLM for selection. In some cases, the approach of the present embodiments can leverage interpretable language models and can incorporate a self-assessment mechanism. In some cases, by employing conformal prediction techniques, statistical guarantees on the accuracy of the data generation during schema linking can be provided, thereby enhancing the robustness and reliability of the entire query generation.

The present embodiments advantageously provide a combination of transparent-box LLMs with human-in-the-loop approaches to generate a substantially robust and industry-ready approach for natural language interfaces to databases. The present embodiments can be used to automatically detect uncertainty during schema linking and abstain from generating potentially erroneous queries. Additionally, the present embodiments include approaches to instigate human intervention when required allowing the model to employ auto-correction based on expert feedback. In some cases, the present embodiments can be adopted as an addon, such as by a transparent-box LLM responsible for schema linking.

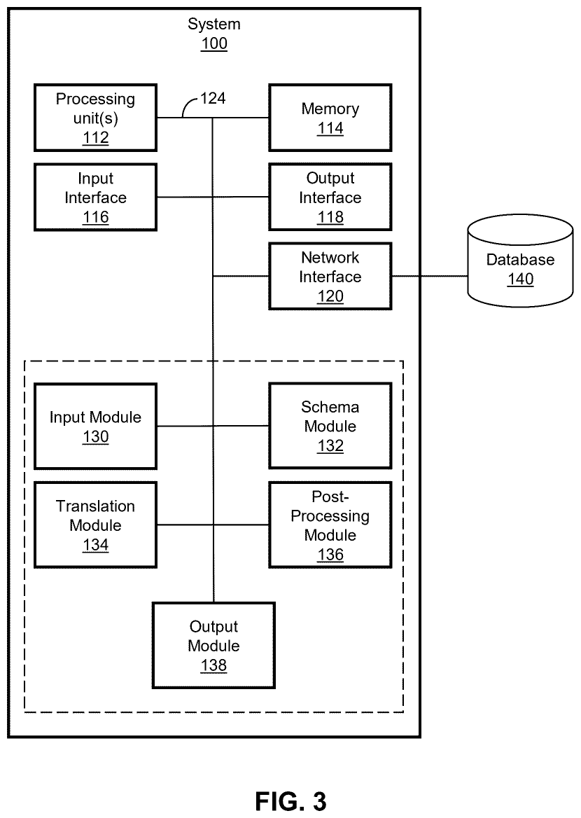

Referring now to FIG. 3, a system for conversion of natural language text to structured query language 100, in accordance with an embodiment, is shown. The system 100 can be communicatively linked to a database 140. In an embodiment, the system 100 has a number of physical and logical components, including one or more processing units 112 (each comprising one or more processors), memory 114, an input interface 116, an output interface 118, a network interface 120, and a local bus 124 enabling the one or more processing units 112 to communicate with the other components. The one or more processing units 112 execute various conceptual modules, as described below in greater detail, in addition to other software. The memory 114 provides relatively responsive storage to the one or more processing units 112. The memory 114 can include non-transitory computer-readable medium that stores instructions for execution by the one or more processing units 112 to perform the operations of the methods described herein. The input interface 116 enables an operator to provide input via an input device, such as a keyboard, mouse, touchscreen, or the like. The output interface 118 outputs information to output devices, such as a display, screen, speakers, or the like. In some cases, the input interface 116 and the output interface 118 can be the same device (e.g., a touchscreen or tablet computer). The network interface 120 permits communication with other computing or storage devices, such as the database 140, which can be locally or remotely located from the system 100. The network interface 120 may also permit communication with various kinds of remote storage, such as cloud-based storage.

In various embodiments, the one or more processing units 112 can be configured to execute a number of conceptual and/or functional modules, for example, an input module 130, a schema module 132, a translation module 134, a post-processing module 136, and an output module 138. In further cases, functions of the above modules can be combined or executed on other modules. In some cases, functions of the above modules can be executed on remote computing devices, such as centralized servers and cloud computing resources communicating over the network interface 120.

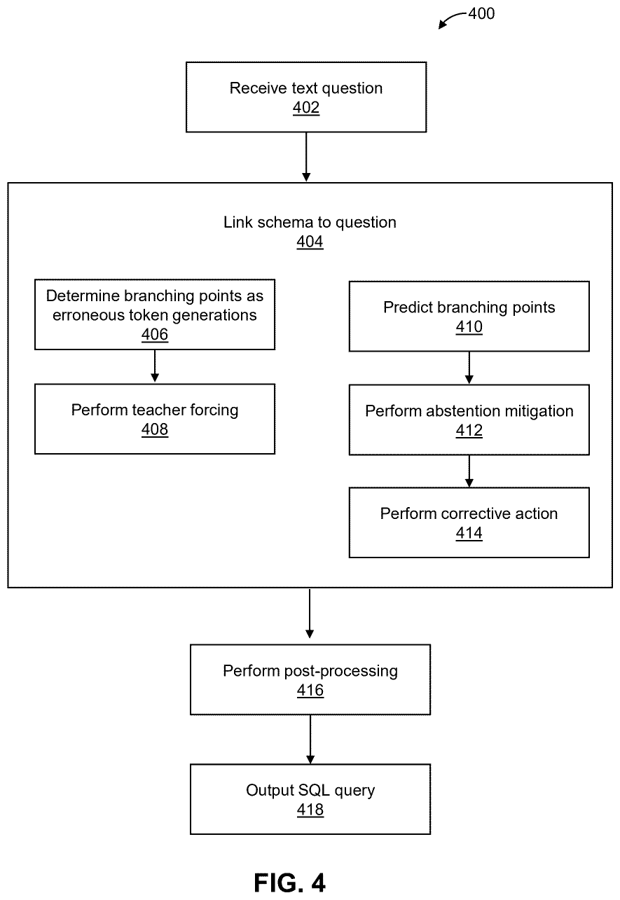

FIG. 4 illustrates a method for conversion of natural language text to structured query language 400 for query of a database ‘D’, according to an embodiment.

At block 402, the input module 130 receives a natural language question, referred to as ‘Q’, via the input interface 116 or network interface 120.

At block 404, the schema module 132 links schema to the question Q, in order to aide SQL generation. Schema linking includes identifying relevant columns and tables in the database 140 that are required to answer the received natural language query Q. At a high level, this can include querying an LLM after supervised fine-tuning. This LLM (which can be referred to as a schema linking model) accepts a natural language query as input (along with the database schema and other applicable metadata) and outputs tables and columns relevant to the query.

In an example, given a database D with tables [symbol] ={T₁, T₂, . . . , Tᵥ}, columns cᵢ={cᵢ₁, cᵢ₂, . . . , cᵢₓ} for each table Tᵢ, and the natural language question Q, a goal of the schema linking can be to (1) identify the relevant tables [symbol] ′⊆ [symbol] for forming an answer to Q (referred as table linking), and (2) extract relevant columns c′ᵢ from cᵢ for each table Tᵢ∈ [symbol] ′ for forming an answer to Q (referred as column linking). These lists of tables [symbol] ′ and columns c′ can be used to formulate an SQL query that answers the question Q.

Accurate schema linking enhances the downstream construction of complex SQL queries. To demonstrate the significant impact of schema linking on the accuracy of generating complex SQL queries, the present inventors conducted example experiments that involved supervised fine-tuning of a small-scale language model Deepseek-7B on the BIRD training dataset, using various schema configurations: (1) only the relevant tables and columns are provided (Correct tables+Correct columns), (2) the relevant tables are provided but might include irrelevant columns (Correct tables+Full columns), and (3) the entire database schema is used (Full tables+Full columns). The effectiveness of each configuration was measured based on execution accuracy, which is determined by comparing the execution results of both the predicted queries (the queries provided by the text-to-SQL model) and the gold queries (ground-truth annotated SQL queries) against the BIRD database.

As demonstrated in Table 1, even a small-scale language model, when coupled with accurate schema linking, achieves better performance than large-scale language models like GPT-4 as reported on the BIRD leader board, such as Gemini that has a score 66.95; which is slightly better than one with correct tables+correct columns utilizing an orders of magnitude smaller model.

TABLE 1

| Schema Linking Configuration | Execution Accuracy (EX) |
|---|---|
| Correct tables + Correct columns | 66.21 |
| Correct tables + Full columns | 57.26 |
| Full tables + Full columns | 50.07 |
| Best reported GPT-4 based approach | 63.36 |
| Gemini | 66.95 |

Perfect schema linking is challenging due to semantic complexity as schemas contain nuanced relationships and naming conventions, requiring deep comprehension across domains. Additionally, due to external knowledge integration as linking often needs domain-specific information beyond the schema, which can be difficult to acquire and integrate. Further due to language ambiguity as queries may contain ambiguous terms, requiring contextual understanding to resolve accurately.

Schema linking complexities generally demand substantial effort in optimization, curation, and customization, especially in new environments. The system 100, in contrast, provides an error-aware abstention mechanism to enhance model reliability. This allows flagging potential errors, mitigating erroneous mappings, and improving pipeline trustworthiness. Integrating abstention is important for adoption and reliability. It reduces engineering overhead in new domains and establishes a feedback loop for continuous learning, facilitating integration into existing workflows.

The schema linking of the present embodiments has the ability to abstain, which has at least three major advantages:
Computation efficiency: abstaining during pre-processing significantly reduces unnecessary computations, which are most likely to lead to erroneous SQL queries, thereby enhancing efficiency during SQL generation.
Seamless integration with advanced models: the conversion module 132 facilitates the seamless integration of newly developed text-to-SQL models in the SQL generation phase without extensive re-engineering. This particularly advantageous as SQL generation models are consistently advancing in effectiveness and the present approach is agnostic to the SQL generation model. Abstention during schema linking ensures that only high-confidence schemas are delivered to the SQL generation models, thereby improving overall performance and reducing errors.
Safeguards against low-confidence predictions: abstention enhances the overall reliability by safeguarding against low-confidence predictions. During abstention, as described herein, other techniques, such as human-in-the-loop, can be employed to ensure the determinations progress with accuracy; thereby allowing the system 100 to continue generation while maintaining the system reliability.

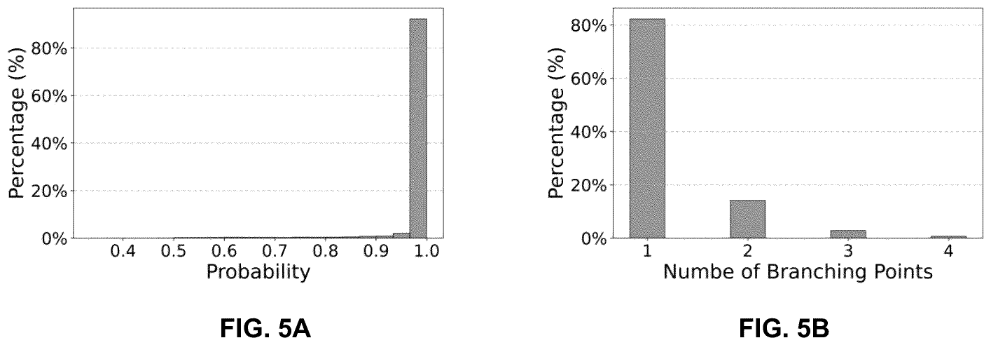

Generally, quantifying uncertainty in LLM predictions is a challenge due to the nuances of language semantics and form. Certain approaches can be used that leverage entropy, semantic analysis, and logits or hidden state information to quantify uncertainty in pre-trained LLMs during generation. However, the text-to-SQL conversion meaningfully differs from free-form language generation. Firstly, the generation task is semi-structured, where the LLM is requested to output only a list of tables and columns present in the given schema. Secondly, a supervised fine-tuned LLM for schema linking is used. Generally, supervised fine-tuned LLMs exhibit over-confidence in their predictions. Namely, during answer generation, the probability distribution of the next generated token is highly skewed, regardless of the correctness of the generation. As an example, the present inventors recorded the softmax probability during schema-linking generation using a supervised fine-tuned Deepseek model on the BIRD development dataset. As illustrated in FIG. 5A, the output probabilities are concentrated around 1 for both correct and incorrect schema predictions. This phenomenon renders useless any logit-based approach built on the intuitive expectation that an error in the generation is likely to correspond to a token generated with low probability values. FIG. 5A shows distribution of probability for generation and FIG. 5B shows distribution of number of branching points.

For the above reasons, at block 406, the schema module 132 identifies erroneous token generations during the schema linking. In the present context, the tokens are units of text representing names (i.e., strings of data) of a database schema element (i.e., a column or a table) in the database. This identification proceeds by examining the errors made during the schema-linking process (using ground truth data) for accurate Text-to-SQL generation. The ground truth data is derived from the training data; whereby the ground truth is the set of column and table names in the training data that are relevant to a given text query (i.e., those that are used in the correctly generated SQL). For example, the ground truth can be obtained by determining the table and column names used in the correct SQL, which form part of a benchmark dataset used for training.

Let [symbol] be the set of tables the schema module 132 has to schema link against. Let [symbol] ^{t} be the set of tokens in these tables. The model's token level generation is constrained to only generate tokens in [symbol] ^{t} utilizing constraint generation. The model's token-level generation is denoted for a specific schema linking instance, as \hat{x}₁, . . . , \hat{x}ₘ, while the ground truth tokens are x₁, . . . , xₘ. Each generated token \hat{x}ᵢ is compared with the corresponding ground truth token xᵢ, and the first token where the model generation deviates from ground truth is referred to as the branching point, denoted as \hat{x}_{b} for the generated token and \hat{x}_{b} for the ground truth token. Formally, the branching point satisfies the following conditions: \hat{x}_{b}≠x_{b}, and for all i<b, \hat{x}₁=xᵢ. In other words, the branching point indicates the position where the model generation begins to diverge from the correct sequence, marking the first mistake made by the model.

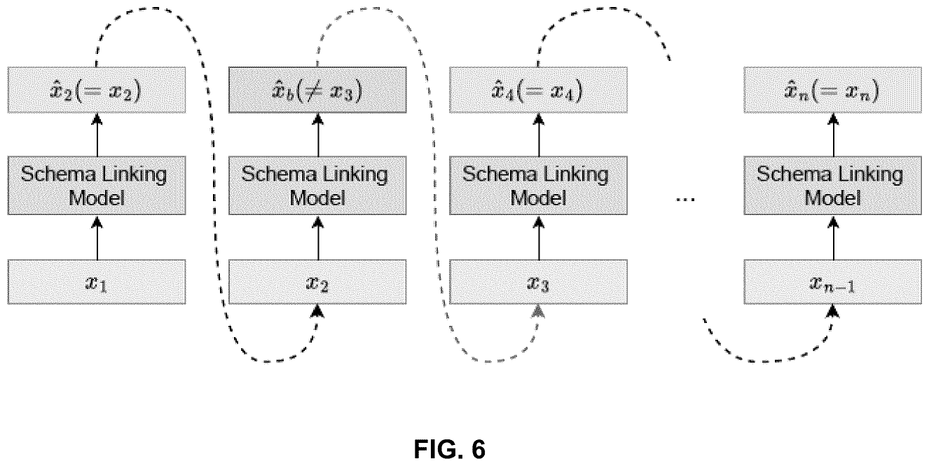

At block 408, at the branching point, the schema module 132 performs a corrective action that comprises teacher forcing; which replaces the incorrect token with the corresponding correct ground truth token; allowing the model to continue generating without the erroneous token. This is illustrated by the arrow leading to the third column in FIG. 6. Teacher forcing is repeated until the entire generation, or a substantially portion thereof, of the model matches the ground truth. In some cases, during each teacher forcing step, the schema module 132 intervenes to correct the mistake made by the model and continue the generation until, for example, the schema module 132 encounters a new branching point or the generation is complete. Hence, it is possible that multiple branching points may be identified during a single answer generation; i.e., the model mistakenly deviates from the correct generation after correcting the previous mistake, one or more times.

To highlight the above, the present inventors conducted an example experiment on the BIRD development dataset with a supervised fine-tuned DeepSeek model on the corresponding training data. The present inventors recorded the number of branching points within each erroneous generation, as shown in FIG. 5B. In this experiment, two important observations were made:
The number of branching points during erroneous schema linking is small for each schema linking operation, with more than 90% of the erroneously generated sequences containing only one or two branching points.
If these branching points can be detected and fixed, the model generates the correct schema linking result.

Based on the above observations, if the system 100 can accurately and effectively identify branching points during answer generation, such identification can be used as a basis of an abstention mechanism. Moreover, since the number of branching points in each generation is small, it is possible to progressively correct the model output by human intervention. Therefore, advantageously, branching points can be used as a measure of uncertainty during schema linking generation. Specifically, the uncertainty over generating the next token xᵢ is represented by the probability that the generated token is a branching point.

FIG. 6 is a diagram showing that during the generation of schema linking tokens, the schema module 132 can compare the predicted token with ground truth. If the prediction diverges from ground truth, as in the prediction \hat{x}₃, teacher forcing will provide the correct token x₃ to the input to continue generation.

At block 410, the schema module 132, instead of determining branching points as erroneous token generations, predicts branching points (thereby acting as a branching point predictor (BPP)) taking each hidden state as input; i.e., predicting when tokens deviate from ground truth. The BPP is particularly advantageous during deployment where there is no longer access to ground truth in the training dataset, and thus, once trained, the operation of the schema module 132 does not depend on the availability of ground truth. The schema module 132 constructs one classifier per hidden state and utilizes the results during each token generation to quantify the probability of that token being a branching point. Specifically, the schema module observes [symbol] schema linking queries posed to the schema linking model containing both correct as well as erroneous generations. For each schema linking query, the availability of the correct schema linking output (ground truth) can be assumed. The schema module 132 traces each answer generation one token at a time and constructs the dataset:

$${d}_{l} = {\{ ( {h}_{1}^{i} , … {h}_{n}^{i} ) , ( {s}_{1}^{i} , … , {s}_{n}^{i} ) \}}_{i = 1}^{m}$$

$${𝒟}_{branch} = {\{ {d}_{l} \}}_{l = 1}^{𝒩}$$

where dₗ represents a single generation process (i.e., the answer of the LLM for a specific schema linking task for a given query) involving m tokens in a network with n layers. Within this generation,

$${h}_{j}^{i}$$

is the j-th hidden state vector for the i-th token, and

$${s}_{1}^{i} = … = {s}_{n}^{i}$$

is a set of boolean variables indicating the ground truth value of the corresponding token (whether the i-th token corresponds to a branching point, assuming values 1 if it is and 0 otherwise). [symbol] _{branch} is the set of all dₗ over [symbol] schema linking queries.

[symbol] _{branch} is used to train n classifiers, one for each hidden layer, denoted as u₁ . . . uₙ, each consisting of a suitable classifier; such as a two-layer perceptron (MLP) classifier. During a brand new schema linking query, a set of hidden state vectors (one per layer) will be produced for each token during inference. The classifiers u₁ . . . uₙ, when they are provided with the hidden state vector corresponding to their layer will output scores ŝ₁, . . . ŝₙ for the corresponding token. The score ŝᵢ, 1≤i≤n constitutes a prediction at each layer by the schema module 132 signifying whether the specific token been generated is a branching point, according to the classifier uᵢ.

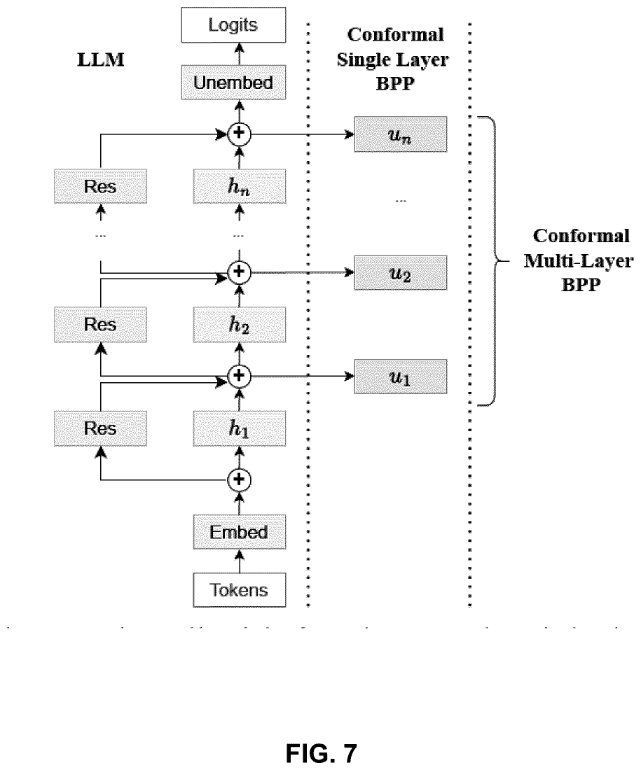

FIG. 7 is a diagram of an example implementation of the branching point prediction, where calibrated classifiers per layer are trained to predict branching points. The predictions are aggregated to produce a final prediction.

The branching point predictor performed by schema module 132 utilizes the classifier predictors u₁, . . . , uₙ that encompass probabilistic guarantees for the detection of branching points during schema linking token generation.

Let (x, y) be a random pair with joint distribution D on [symbol] × [symbol] , where [symbol] is the feature space and y is the label space. For a given error level α∈(0,1), for any classifier, conformal prediction constructs a prediction set C: [symbol] → [symbol] such that:

$$p ( y ∈ C ( x ) ) \geq 1 - α$$

Note that C(x) is a subset of the label space and conformal prediction bounds the probability that the correct label is a member of that set. This guarantee is valid under the assumption of data exchangeability, which is a weaker condition than the independent and identically distributed (i.i.d.) assumption. It remains applicable, albeit in a modified form, even when this assumption is not met, thereby extending its generality and applicability. Let (x₁, y₁), . . . , (x_{N}_{_{d}}, y_{N}_{_{d}}) be the held-out calibration data, and (xₜₑₛₜ, yₜₑₛₜ) be a test point. Conformal prediction proceeds as follows:
Define a nonconformity measure A:( [symbol] × [symbol] ×( [symbol] × [symbol] )^{N}^{_{d}}→ [symbol] ). The intent of A is to quantify how related/unrelated a new point is to the calibration data. For each y∈ [symbol] , the schema module 132 can compute its nonconformity score as follows:

$${R}_{i} = A ( ( {x}_{i} , {y}_{i} ) , ( {x}_{j} , {y}_{j} ) : j \neq i ) , fori = 1 , … , {N}_{d}$$

$${R}_{t e s t}^{y} = A ( ( {x}_{t e s t} , y ) , ( {x}_{i} , {y}_{i} ) : i = 1 , … , {N}_{d} )$$

The π-value for each y can be determined by:

$$π ( y ) = \frac{\vert i : {R}_{i} \geq {R}_{t e s t}^{y} \vert + 1}{{N}_{d} + 1}$$

The prediction set is then defined as:

$$C ( {x}_{t e s t} ) = \{ y ∈ 𝒴 : π ( y ) > α \}$$

Under the assumption that [symbol] × [symbol] is exchangeable, the prediction set satisfies p(y∈C(x))≥1−α.

The schema module 132 can perform branching point prediction (BPP) using either conformal single layer BPP (sBPP) or conformal multi-layer BPP (mBPP). For sBPP, the schema module 132 can use a conformal prediction approach to construct prediction sets for a classifier uᵢ. This classifier assigns scores to tokens generated at layer i of the schema linking model, indicating the probability (a score) of each token being a branching point, as depicted in FIG. 7.

The classifier u; will be trained using data from [symbol] _{branch}, specifically the i-th hidden state vectors and all tokens from schema linking tasks dᵢ∈ [symbol] _{branch}, along with their corresponding ground truth values

$${h}_{i}^{j} , {s}_{i}^{j} ,$$

1≤j≤m, ∀l, dₗ∈ [symbol] _{branch}). Let Dⁱ denote this dataset, and

$${D}_{c}^{i}$$

be a subset of Dⁱ designated as the calibration set. The training of uᵢ will utilize the data in

$${D}^{i} ∖ {D}_{c}^{i} .$$

Each observation in the calibration set comprises a feature vector xᵢ∈ [symbol] (i.e., the hidden state vector hᵢ for a given token) and its associated ground truth label yᵢ∈ [symbol] (i.e., the value sᵢ for that token, indicating whether it is a branching point).

Utilizing this calibration dataset, the schema module 132 determines a non-conformity score of a data point x as 1−p(y*|x), where p(y*|x) is the softmax probability of the true class y* for classifier uᵢ. This score quantifies the degree of deviation or non-conformity of a new observation from the training data distribution. Note that the non-conformity score increases when the classifier uᵢ makes an incorrect prediction (as the evaluation takes place utilizing ground truth data at this stage).

A threshold ϵ can be determined as the

$$⌈ ( \vert {D}_{c}^{i} \vert + 1 ) ( 1 - α ) / \vert {D}_{c}^{i} \vert ⌉$$

th quartile of the non-conformity scores computed over the calibration set, where

$$\vert {D}_{c}^{i} \vert$$

denotes the cardinality of the calibration set. For a new test point xₜₑₛₜ, the schema module 132 generates the prediction set as:

$$C ( {x}_{test} ) = \{ y \vert p ( y \vert {x}_{t e s t} ) \geq 1 - ϵ \}$$

Under the assumption of exchangeability for the calibration dataset

$${D}_{c}^{i} ,$$

it can be guaranteed that:

$$p ( {y}^{*} ∈ C ( {x}_{t e s t} ) ) \geq 1 - α$$

where y* represents the true label for xₜₑₛₜ. This approach allows for the generation of prediction sets with a specified error level, providing a foundation for the detection of branching points.

In many cases, exchangeability cannot be assumed, and non-exchangeable conformal prediction can be utilized. The approach is similar, however, processing of the calibration set and determining of the threshold ϵ are adjusted to account for the differences between the distributions of the test data and calibration data. The schema module 132 transforms

$${D}_{c}^{i}$$

by associating each hidden state vector

$${h}_{i} ∈ {D}_{c}^{i}$$

with its non-conformity score σᵢ=1−p(y|hᵢ) utilizing uᵢ. Let

$${D}_{c}^{i ′}$$

be the transformed calibration set of pairs (hᵢ, σᵢ). At test time, given a test hidden state h*, the schema module 132 determines its K nearest neighbors in

$${D}_{c}^{i ′}$$

and determines the weights

$${w}_{k} = exp ( - {‖ {h}^{*} - {h}_{k} ‖}_{2}^{2} / τ )$$

for a hyper-parameter τ and 1≤k≤K. In this way, the system 100 is assessing the “influence” each calibration point has on the test point at hand. After normalization

$${\hat{w}}_{i} = {w}_{i} / ( 1 + {\sum }_{i = 1}^{K} {w}_{i} ) ,$$

the schema module 132 determines a new threshold

$$\hat{ϵ} = inf \{ ϵ \vert {\sum }_{i = 1}^{K} {\hat{w}}_{i} 1 \{ {σ}_{i} < ϵ \} \geq 1 - α \} ,$$

where 1{.} is an indicator function. The estimation proceeds as in the exchangeable case; the bound of p(y∈C(x))≥1−α is slightly looser in the non-exchangeable case, which can incorporate correction terms.

For mBPP, the schema module 132 can repeat the construction in sBPP, above, for each of the n classifiers u₁ . . . uₙ. Let Cᵢ=Cᵢ(x)⊆{0,1} denote the conformal prediction set derived by uᵢ on some input x. This set includes the labels (0, 1, or both) predicted by classifier uᵢ for the corresponding token. For ease of notation, it can be assumed that for the calibration set of each uᵢ exchangeability holds, but the following applies equally for the non-exchangeable case.

The schema module 132 can aggregate the predictions of the classifiers to determine whether the test token is a branching point. Specifically, let C₁, C₂, . . . . Cₙ denote the prediction set generated by the n branching point predictors uᵢ, each based on a different hidden layer in the schema linking model. Given a threshold θ∈[0,1), C^{θ} is defined to include all predictions (0 or 1) that appear in at least θ fraction of the prediction sets,

$${C}^{θ} = \{ c ∈ \{ 0 , 1 \} \text{:} \frac{1}{n} {\sum }_{i = 1}^{n} 1 \{ c ∈ {C}_{i} \} > θ \}$$

which has advantageous properties as described below.

Let C₁, . . . , Cₙ be prediction sets with properties as per p(y∈C(x))≥1−α and let c* denote the correct label. Then,

$$p ( {c}^{*} ∈ {C}^{θ} ) \geq 1 - α / ( 1 - θ )$$

The proof of the above is as follows:

$$p ( {c}^{*} ∉ {C}^{θ} ) = p ( \frac{1}{n} {\sum }_{i = 1}^{n} 1 \{ {c}^{*} ∉ {C}_{i} \} \geq 1 - θ )$$

Noted that 1{c*∉Cᵢ} is a Bernoulli random variable (referred to as φᵢ), with its expectation E(φᵢ)≤α. Therefore, by Markov's inequality,

$$p ( {c}^{*} ∉ {C}^{θ} ) = p ( \frac{1}{n} {\sum }_{i = 1}^{n} {ϕ}_{i} \geq 1 - θ ) \leq \frac{E ( \frac{1}{n} {\sum }_{i = 1}^{n} {ϕ}_{i} )}{1 - θ} = \frac{\frac{1}{n} {\sum }_{i = 1}^{n} E ( {ϕ}_{i} )}{1 - θ} \leq \frac{α}{1 - θ}$$

$$Thus ,$$

$$p ( {c}^{*} ∈ {C}^{θ} ) = 1 - p ( {c}^{*} ∉ {C}^{θ} ) \geq 1 - α / ( 1 - θ )$$

The above proof makes no assumptions on how the prediction sets Cᵢ are related. In an example, for the special case of θ=½, it can become the majority vote and it can be specified that by aggregating the predictions for the labels, the majority vote provides a marginal probability guarantee of at least 1−2α. The actual guarantee depends on the properties of sets Cᵢ. For example, if the sets Cᵢ are independent, for θ=½ it can be shown using Hoeffing's inequality that the probability of a false negative is at most exp^{(-2n(1/2-α)}^{²}⁾, which goes to 0 fast as n increases (the number of layers of the networks and thus the corresponding number of classifiers increases). Alternatively, if all the sets are the same, the probability of a false negative is upper-bounded by α. The majority vote provides a balance between false negatives (missing a branching point) and false positives (erroneously declaring a point as branching when it is not). For the purposes of system 100, false negatives are generally harmful as they will lead to erroneous schema linking. False positives, however, when present, are not as harmful in the sense of providing wrong schema linking information. Instead, false positives can trigger abstention or human intervention; but should be minimized as well.

The present inventors have determined that the size of C^{θ}, in the worse-case, can be bounded. Let |C₁|, . . . , |Cₙ| denote the size of each prediction set. Then,

$$\vert {C}^{θ} \vert \leq \frac{1}{n \cdot θ} {\sum }_{i = 1}^{n} \vert {C}_{i} \vert$$

The proof of the above is as follows:

$$\begin{matrix}\vert {C}^{θ} \vert = {\sum }_{c} 1 \{ \frac{1}{n} {\sum }_{i = 1}^{n} 1 \{ c ∈ {C}_{i} \} \geq θ \} \leq {\sum }_{c} \frac{1}{n \cdot θ} {\sum }_{i = 1}^{n} 1 \{ c ∈ {C}_{i} \} \\ = \frac{1}{n \cdot θ} {\sum }_{i = 1}^{n} ( {\sum }_{c} 1 \{ c ∈ {C}_{i} \} ) = \frac{1}{n \cdot θ} {\sum }_{i = 1}^{n} \vert {C}_{i} \vert\end{matrix}$$

where the first inequality is based on the fact 1{x≥1}≤x.

Notice that for θ=½, |C^{θ}| is ≤2·avg(|Cᵢ|). In some cases, to further constrain the size of the aggregated prediction sets, an observation regarding random permutations can be used. The prediction sets C₁, . . . , Cₙ can be aggregated by randomly permuting their indices and constructing the final prediction set C^{π} based on majority voting criteria, similar to above. In an example, occurrences of labels 0 and 1 can be iteratively counted across each element in the permutation, considering all prefixes of the permutation ending in index i (for 1≤i≤n) by adding an element to the prediction for this prefix C^{π}(π₁:πᵢ) if its occurrence meets or exceeds half of the current iteration index i. The final result C^{π} contains elements that are supported by each prediction set across all prefixes.

In an example, the random permutation approach can comprise the following:

```
Require: Prediction Sets C₁, . . . , Cₙ
Ensure: An aggregated prediction set C^{π}
  C^{π} ← ∅
  π₁ . . . πₖ ← random permutation of {1, 2, . . . , n};
  for each i in range 1 . . . k do
    C^{π} (π₁:πᵢ) ← ∅
    Count₀ ← count number of occurrences of 0 in C_{π}_{₁} . . . C_{π}_{ᵢ}
    Count₁ ← count number of occurrences of 1 in C_{π}_{₁} . . . C_{π}_{ᵢ}
    $if {Count}_{0} \geq \frac{i}{2} then$
      C^{π} (π₁:πᵢ) ← C^{π} (π₁:πᵢ) + {0}
    end if
    $if {Count}_{1} \geq \frac{i}{2} then$
      C^{π} (π₁:πᵢ) ← C^{π} (π₁:πᵢ) + {1}
    end if
    C^{π} ← C^{π} ∩ C^{π} (π₁:πᵢ)
  end for
```

The worst-case marginal probability guarantee for the above random permutation approach is the same as that of the case of θ=½; however, the size of the prediction set it produces could be smaller. Let C₁, . . . , Cₙ be prediction sets according to p(y∈C(x))≥1−α. Then,

$$p ( {c}^{*} ∈ {C}^{π} ) \geq 1 - 2 α$$

and |C^{π}|≤|C^{θ}| when θ=½.

The proof of the above is as follows. Let φₖ=1{c∈Cₖ}. By conformal prediction, it is known that E[φₖ]≤α.

$$\begin{matrix}p ( {c}^{*} ∉ {C}^{π} ) = p ( ∃ k \leq K \text{:} c ∉ {C}^{π} ( {π}_{1} \text{:} {π}_{k} ) ) \\ = p ( ∃ k \leq K \text{:} \frac{1}{k} {\sum }_{i = 1}^{k} {ϕ}_{{π}_{i}} \geq \frac{1}{2} ) \leq 2 E [ {ϕ}_{i} ] \leq 2 α\end{matrix}$$

where the first inequality follows the exchangeable Markov inequality (EMI). The second part |C^{π}|≤|C^{θ}| is obvious as C^{π}(π₁:πₙ) is the same as C^{θ}.

Since the random permutation approach, above, provides the same probability guarantees with a smaller prediction set compared to majority voting, it can be employed by the schema module 132 to aggregate the results over mBPP, and it can, for example, label the token as a branching point if and only if 1 appears in the final prediction set C^{π}.

Upon identification of a branching point (i.e., identified that the generated token is erroneous), the schema module 132 can cease further generation. In some cases, at block 412, the schema module 132 performs mitigation through abstention (i.e., ceasing generation) and either performing self-correction or soliciting human intervention. A table trace back approach, detailed below, can be initiated following the identification of a branching point in order to yield a list of tables for inspection. This approach accepts three inputs along with the schema linking model: the set of potential tables [symbol] for linking, the sequence of tokens generated up to that point, and the identified branching point. It utilizes a decode function that takes as arguments a sequence S of tokens and the set of tables [symbol] . The decode function operates by concatenating the tokens in S from left to right to form table names, which are then compared against the tables in [symbol] . The list of tables returned is determined by the set difference of the decode result computed on the sequence before and after the branching point. When applying decode in the sequence after the branching point, if a token subsequence of S cannot be matched to any table name (note that such a subsequence will invariably be a suffix of S), generation is continued until a next table in [symbol] is identified by decode.

Using the table trace back approach, in order to permit generation to continue, the list of tables for inspection can be used to identify what type of assistance is required by formulating a question to the user. In an example, the table trace back approach can comprise the following:

```
Require: A branching point token x_{b}, Set of generated tokens X = x₁ ... x_{b}, Set of possible
tables [symbol]     = {T₁ ... Tᵥ}, Schema Linking Model M
Ensure: [symbol]    _{b} ⊂ {T₁ ... Tᵥ} The corresponding possible erroneous tables. [symbol]
  ₚᵣₑ ← decode X[:−1] = x₁ ...x_{b-1} into a set of tables [symbol]    ₚᵣₑ ⊂ [symbol] [symbol]
  _{after} ← decode X into a set of tables [symbol]    _{after} ⊂ [symbol]
  while [symbol]    _{after} − [symbol]    ₚᵣₑ = Ø do:
    x_{new} ← generate the next token using M and X
    if x_{new} = eos then [symbol]
      _{b} ← [symbol]    [−1:]
    end if
    X ← X + x_{new} [symbol]
    _{after} ← decode X into a set of tables [symbol]    _{after} ⊂ [symbol]
  end while
  return [symbol]    _{b} ← [symbol]    _{after} − [symbol]    ₚᵣₑ
```

Upon identification of a branching point, in some cases, at block 414, the schema module 132 performs a corrective action involving attempting to rectify the erroneous token prediction. The table trace back approach, above, yields a set of one or more tables to which the branching point is attributed. These tables may either indicate a source of ambiguity within the schema or suggest that the model erroneously predicts these tables, potentially impeding further generation.

In a particular case, the corrective action can include the following mitigation approach: Let [symbol] _{b} denote the set of tables returned by table trace back approach. A surrogate model (e.g., Deepseek-7B) can be used to classify whether the tables in [symbol] _{b} are indeed relevant or irrelevant to the query under consideration. The surrogate model can be fine tuned utilizing suitable training datasets; for example, the BIRD and Spider training datasets. In this way, the model is able to provide answers to the following classification problem: Given a schema and a query, is a provided set of tables relevant to the query or not? The following prompt can be formulated using [symbol] _{b}, the Schema, and the question Q as input to the surrogate model:

{ Schema }
Question : { Question }
Is the ′{‘ [symbol] _{b}}′ relevant to the question:
(A) True (B) False

The schema linking halts when the surrogate model confirms the irrelevance of these tables by outputting “False”; otherwise it continues. In some cases, the same approach can be utilized for columns as well.

Any suitable LLM can be used for the surrogate model, for example, a generative pre-trained transformer model or the DeepSeek family of models.

In other cases, upon identification of branching points, instead of using the surrogate model, the corrective action can include, if correction is feasible, enabling the continuation of token generation, potentially leading to the correct answer. In such cases, self-corrections can be based on human feedback received by the input interface 116. Such approach generally relies on the assumption that the human participant will consistently provide valuable assistance by offering accurate information in response to queries posed by the system 100.

When a token is identified as a branching point, the table trace back approach can be used to trace back to the corresponding tables, yielding a set [symbol] _{b}. Subsequently, the schema module 132 prompts for user interaction. For each table Tᵢ∈ [symbol] _{b}, the schema module 132 solicits user confirmation regarding its relevance to the query; i.e., whether the table or attribute identified is relevant to the query. If the user affirms the table's relevance, token generation proceeds without further intervention, utilizing the tokens in Tᵢ. Conversely, if the user deems all tables Tᵢ∈ [symbol] _{b} irrelevant, the schema module 132 requests the correct table name. The provided table name and its associated tokens are then utilized to continue generation.

At block 414, the translation module 134 uses an LLM to translate the question Q into an SQL query. The LLM takes the linked schema (i.e., the table names and the attributes from schema linking determined by the schema module 132), and the question Q, as input to the LLM. Using the schema linking determined by the schema module 132, token generation is improved during answer formation; specifically, in the predicted tables and columns pertinent to the query having identified the critical branching points.

At block 416, in some cases, the post-processing module 136 performs post-processing on the SQL query outputted by the translation module 134. The post-processing can include one or more of, for example, (1) self-correction that uses trained models to review the outputted SQL, (2) self-consistency where multiple valid queries are executed and a voting scheme determines the most consistent or reliable outputted query, and (3) execution-guided SQL selector where SQL queries are sequentially generated and the first error-free execution is selected.

At block 418, the output module 138 outputs the SQL query, with or without post-processing, to the memory 114, the input Interface 116, the output Interface 118, and/or the network interface 120.

The present inventors conducted example experiments to illustrate the substantial advantages of the present embodiments. The example experiments included empirical evaluations using two relational schema-to-SQL query generation benchmarks: Spider and BIRD. The example experiments utilized a training corpus to train the LLM and assess its efficacy on the validation and test datasets. The example experiments illustrated how the system 100 enhances the robustness of natural language to SQL query translation.

Given that the system 100 in most cases produces an output with a non-standard schema (such as incorporating abstention), it may be incompatible with test set specifications and the example experiments were unable to evaluate the approach on hold-out test data. As a result, performance metrics and reliability assessments were conducted on a publicly accessible validation set, which allows for more granular analysis of query execution plans, optimization strategies, and schema comprehension.

Two popular text-to-SQL benchmarks were used for the example experiments:
The Spider benchmark is a comprehensive dataset for evaluating text-to-SQL generation models, containing a training set with 8,659 samples, a development set with 1,034 samples, and a hidden test set. It includes 200 databases with different schemas and domains, along with complex SQL queries paired with natural language questions. The benchmark requires generalization across diverse databases and handling of intricate SQL structures.
The BIRD benchmark evaluates text-to-SQL with a focus on large-scale and more varied data. It includes a training set of 9,428 samples, a development set with 1,534 samples, and a hidden test set. BIRD encompasses 95 databases across 37 distinct domains and presents a substantial challenge with “dirty” values that retain the original, often non-standard format from real-world scenarios. Moreover, BIRD offers external knowledge for specific samples to facilitate the generation of the correct SQL query. In this way, text-to-SQL parsers must not only analyze these non-standard formats but also accurately incorporate external knowledge into the text-to-SQL generation.

While the example experiments use a simple transparent LLM-based schema linking model, it should be understood that any suitable model can be used with the system 100. The example experiments analyze the effectiveness and accuracy of the abstention mechanisms utilized by the system 100 and analyzes their impact on the ensuing schema linking. The example experiments illustrate the increase in reliability of a schema linking model that uses abstention.

The example experiments use LLMs for table linking and column linking, and in particular, Deepseek-7B as a schema linking model. Its performance is evaluated on a development dataset. Additionally, the CodeS LLM can be used for text-to-SQL generation. For both Deepseek-7B and CodeS, supervised fine-tuning was performed on their respective training datasets, ensuring that the models were well-adapted to the text-to-SQL generation for each benchmark.

In the example experiments, unless stated otherwise, the error level α is set to 0.1. Given that the LLM implementing the schema linking model has n layers, the k best performing sBPP classifiers are selected to form the mBPP. To assess the quality of a sBPP, the AUC (Area Under the Curve) scores are determined over the calibration dataset. Unless stated otherwise, k=5 in the example experiments. For all LLMs, greedy decoding was used with a temperature setting of 0 to ensure reproducibility.

The schema linking model was evaluated based on exact set match, precision, and recall. Taking table linking, as an example, let [symbol] ᵢ be the set of ground truth tables for a specific query and [symbol] be the set of predicted tables. Exact Set Match (EM), measures the percentage of instances where the predicted set exactly matches the ground truth,

$$\frac{1}{n} {\sum }_{i = 1}^{n} 1 ( {𝒯}_{i} = \hat{{𝒯}_{i}} ) .$$

Precision is calculated as the number of correct tables predicted (true positives) divided by the total number of tables predicted (true positives plus false positives),

$$\frac{1}{n} {\sum }_{i = 1}^{n} \frac{\vert {𝒯}_{i} ∩ {\hat{𝒯}}_{i} \vert}{\vert {\hat{𝒯}}_{i} \vert} .$$

Recall is calculated as the number of correct tables predicted (true positives) divided by the total number of tables in the ground truth (true positives plus false negatives),

$$\frac{1}{n} {\sum }_{i = 1}^{n} \frac{\vert {𝒯}_{i} ∩ {\hat{𝒯}}_{i} \vert}{\vert {𝒯}_{i} \vert} .$$

The AUC score is used that measures the ability of the model to distinguish between the positive and negative classes in order to evaluate the performance of each Branching Point Predictor (sBPP). To evaluate the performance of the conformal prediction with multiple BPPs, (mBPP), coverage and extra abstention rate (EAR) was used. Let S={s₁ . . . sₙ} denote the ground truth labels for each token and {ŝ₁ . . . ŝₙ} to be the predicted labels. The coverage and EAR are defined as follows:
Coverage is calculated as the percentage of branching points correctly detected by mBPP among all the branching points:

$$Coverage = \frac{\vert \{ i \vert {\hat{s}}_{i} = {s}_{i} = 1 , i ∈ 1 , 2 … n \} \vert}{\vert \{ i \vert {s}_{i} = 1 , i ∈ 1 , 2 … n \} \vert}$$

Extra abstention rate is calculated as the percentage of incorrect predictions of branching points among the entire dataset. It is an indication of the percentage of unnecessary abstention:

$$EAR = \frac{\vert \{ i \vert {\hat{s}}_{i} = 1 , {s}_{i} = 0 , i ∈ 1 , 2 … n \} \vert}{n}$$

Ideally, the aim is to achieve higher coverage with only a small EAR. Increasing a could increase coverage; however, it might simultaneously increase EAR as non-branching points are more likely to be identified as branching points. Therefore, the trade-off between coverage and EAR for BPP was investigated.

To evaluate the present embodiments, three key metrics were investigated: exact set match, false abstention rate, and true abstention rate. For the case of table linking, as an example, (predicting tables relevant to a query q), let ŝ₁ . . . ŝₙ denote the decision of whether to abstain on the test sample. Let T₁ . . . . T_{q} denote the ground truth tables for a query q and \hat{T}ᵢ . . . \hat{T}_{q} be the predicted tables. Then the true abstention rate (TAR) is calculated as the percentage of instances where the model abstains from making a prediction and is not capable of making the correct one.

$$TAR = \frac{\vert \{ i \vert {\hat{s}}_{i} = 1 , {T}_{i} \neq {\hat{T}}_{i} \} \vert}{n}$$

In contrast, the false abstention rate (FAR) is calculated as the percentage of instances where the model abstains from making a prediction despite being capable of making a correct one.

$$FAR = \frac{\vert \{ i \vert {\hat{s}}_{i} = 1 , {T}_{i} \neq {\hat{T}}_{i} \} \vert}{n}$$

Accordingly, TAR measures the percentage of abstentions that correctly capture instances where the model cannot make a correct prediction, while FAR measures the unnecessary abstentions incurred due to detection errors. The exact set match represents the accuracy of predictions in which the model does not abstain.

The example experiments evaluated the downstream text-to-SQL model using execution accuracy (EX). Execution accuracy assesses the correctness of SQL queries generated by the model, comparing their results with ground truth results produced from golden query execution on the database.

The example experiments further evaluated the key components of the present embodiments, namely the schema linking model, sBPP, and the surrogate model.

Table 2 illustrates model performance in scheme linking:

TABLE 2

| Type | Dataset | Exact Match (%) | Precision (%) | Recall (%) |
|---|---|---|---|---|
| Table | Bird | 79.70 | 92.85 | 95.00 |
| Column | Bird | 75.32 | 89.87 | 88.79 |
| Table | Spider | 93.71 | 98.17 | 96.95 |
| Column | Spider | 88.98 | 94.41 | 94.09 |

The results in Table 2 display the baseline performance of the schema linking model across two datasets: BIRD and Spider. The schema linking model performs better for both tables and columns on the Spider dataset compared to the more challenging dataset BIRD. As illustrated, the system 100 abstains from predictions in certain cases, thereby enhancing overall robustness and adaptability. The approach of the present embodiments can be adopted by any suitable transparent schema linking model.

To evaluate the effectiveness of sBPP, the average AUC score was determined for all the sBPP models used in conformal prediction. Table 3 summarizes the results for BIRD and Spider datasets. As is evident from the table, sBPP achieves a near-perfect AUC score for both datasets, suggesting that the sBPP models are effective in this context.

The surrogate model was used as a binary classifier (to assess whether tables/columns are relevant to a query given a schema description) and evaluate its classification accuracy on the development set of the BIRD and Spider benchmarks. The results are illustrated in Table 4. As presented in Table 4, the accuracy is high (>94%) for both benchmarks.

Table 3 shows the average sBPP AUC (%) for the Bird and Spider datasets and Table 4 shows surrogate model accuracy (%) for the Bird and Spider datasets.

TABLE 3

| Type | Bird | Spider |
|---|---|---|
| Table | 97.16 | 98.43 |
| Column | 96.70 | 96.90 |

TABLE 4

| Type | Bird | Spider |
|---|---|---|
| Table | 92.37 | 96.45 |
| Column | 94.06 | 96.30 |

The example experiments considered the case where the system 100 abstains once a branching point is detected by mBPP. In such case, the schema linking was tested for table linking and column linking independently (i.e., column linking will not receive input from the table linking result). This is to minimize the dependency between these two steps and evaluate them independently. The example experiments also demonstrated their joint effect (i.e., identifying the relevant table first, then finding the column for each table) and the implications on the abstention rate. Table 5 summarizes the results showing the schema linking model performance.

TABLE 5

| | | Bird | | | Spider | | |
|---|---|---|---|---|---|---|---|
| Method | Type | EM (%) | TAR (%) | FAR (%) | EM (%) | TAR (%) | FAR (%) |
| mBPP- | Table | 98.89 | 19.10 | 12.77 | 99.86 | 6.51 | 5.27 |
| Abstention | Column | 97.38 | 22.01 | 13.53 | 97.73 | 8.75 | 7.46 |
| Surrogate | Table | 90.80 | 10.90 | 2.2 | 96.77 | 3.05 | 1.70 |
| filter | Column | 89.76 | 14.34 | 5.98 | 92.71 | 3.70 | 3.35 |

Looking at the first row (mBPP-Abstention) of Table 5, both table-level and column-level results demonstrate high exact match score for all the cases where the model decides not to abstain for both BIRD and Spider (achieving EM of 98.89% and 97.38% respectively). In an example, out of 100 queries posed by BIRD, the system 100 will decide to conduct table linking on 68.13% of those, achieving an accuracy of 98.89% in table linking, and abstain on the rest of the queries. Similarly, in 64.46% of those queries the system 100 will conduct column linking achieving 97.38% exact match score and abstain on the rest.

Looking at the second row of Table 5, the experiments analyzed the impact of utilizing the surrogate model. In this case, FAR is reduced significantly, but both EM and TAR are reduced as well. It appears that the application of the surrogate model is able to identify correctly cases when the model should not abstain (thus, reducing FAR).

Thus, in practice both methods (mBPP-Abstention and the use of a surrogate model) achieve better EM when compared to the theoretical error-level α (80% in this case using α=0.1). The surrogate model introduces a trade-off between EM and FAR. While it reduces unnecessary abstentions, it also limits the overall EM by failing to recognize instances beyond the surrogate model's capabilities.

The example experiments further investigated the system 100 where human assistance was received upon encountering branching points. In this approach, the experiments considered a schema linking model that conducts both table and column predictions by first identifying the relevant table, followed by identifying the appropriate columns for each table. In this case, the system 100 abstains if either the table linking or column linking chooses to abstain. Note that if the table and column linking abstain on entirely different instances, the FAR and TAR obtained in this joint process should be proportional to the sum of the FAR and TAR of each component.

Table 6 presents the results of the experiments when human feedback was received each time a branching point was detected. Since table and column linking takes place jointly, TAR and FAR metrics were determined jointly and for this reason, there is one value for TAR and FAR for each benchmark dataset. Notice that both benchmarks achieved at least 96% accuracy for table and schema linking. Compared to the theoretical guarantee (using α=0.1 in this experiment, providing a probability threshold of at least 80%) the accuracy is much better. Notice that the FAR value is also low, pointing to a small number of cases in which a human is involved unnecessarily (namely the system 100 can make the correct prediction independently). Comparing the results for Spider with those on BIRD, the numbers for Spider are slightly better as Spider is considered an easier benchmark. Table 6 shows execution accuracy (%) for downstream text-to-SQL with different schemas.

TABLE 6

| Dataset | Type | EM (%) | TAR (%) | FAR (%) |
|---|---|---|---|---|
| Bird | Table | 96.90 | 18.95 | 13.65 |
| Bird | Column | 96.02 | | |
| Spider | Table | 98.93 | 6.46 | 8.15 |
| Spider | Column | 96.71 | | |

Comparing the results of Table 6 with those in Table 5, for mBPP-Abstention (first row) it can be observed that the False Abstention Rate (FAR) and True Abstention Rate (TAR) for both BIRD and Spider are much lower than the sum of the FAR and TAR obtained when table and column linking are considered independently. This indicates a significant overlap in the inferences where either linking operation abstains. Specifically, if the table linking operation abstains, the column linking operation is likely to do the same.

The example experiments also investigated the performance of text-to-SQL with the schema determined by the system 100, in which human feedback was solicited in downstream LLMs. The results were compared with utilization of a perfect schema linking model (referred to as a ‘golden schema’), where the schema contains only the relevant tables and columns provided to the fine-tuned SQL generators; an upper bound for this text-to-SQL model. Additionally, these results were compared with the best-reported approaches utilizing such model (i.e., DTS-SQL for DeepSeek-7B and CodeS for CodeS-15B). The results are presented in Table 7. It is evident that the upper bound score is much higher than the corresponding best-reported approach, highlighting the importance of correct schema linking. With human assistance, the system 100 was able to achieve near-perfect schema linking (as reported in Table 7) and hence attain an EX value comparable to that of the upper bound. For example, the EX value we achieve with the system 100 and DeepSeek-7B is 65.19% compared to 66.95% with other techniques with BIRD utilizing Gemini; a model orders of magnitude larger than Deepseek-7B.

TABLE 7

| Model | Schema Type | Bird | Spider |
|---|---|---|---|
| Deepseek-7B | Golden Schema | 66.21 | 90.13 |
| | System 100 | 65.19 | 89.10 |
| | DTS-SQL | 55.8 | 85.50 |
| CodeS-15B | Golden Schema | 66.27 | 90.02 |
| | System 100 | 64.72 | 88.90 |
| | CodeS | 58.47 | 84.9 |

During the example experiments, the human assistance does not include actually writing SQL queries but rather is a person familiar with the schema in order to assess tables and columns relevant to a query when asked.

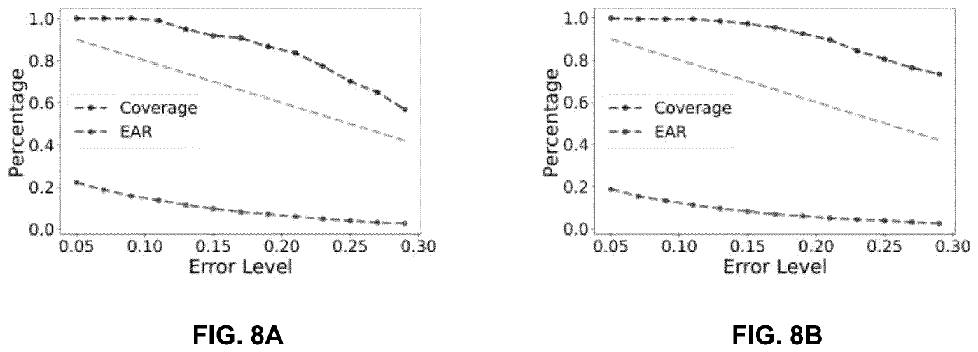

The example experiments further included an ablation study, utilizing the BIRD dataset for brevity. The coverage and EAR for each error level, varying a, are illustrated in FIGS. 8A and 8B. FIG. 8A shows table linking mBPP and FIG. 8B shows column linking mBPP. As shown in the figures, the empirical coverage of mBPP consistently exceeds the theoretical threshold α. The theoretical guarantee is presented as a dotted line that is always enveloped by coverage. Moreover, the empirical coverage remains relatively constant when the threshold is small (<0.15). This behavior indicates that mBPP provides reliable error quantification, especially for lower threshold values

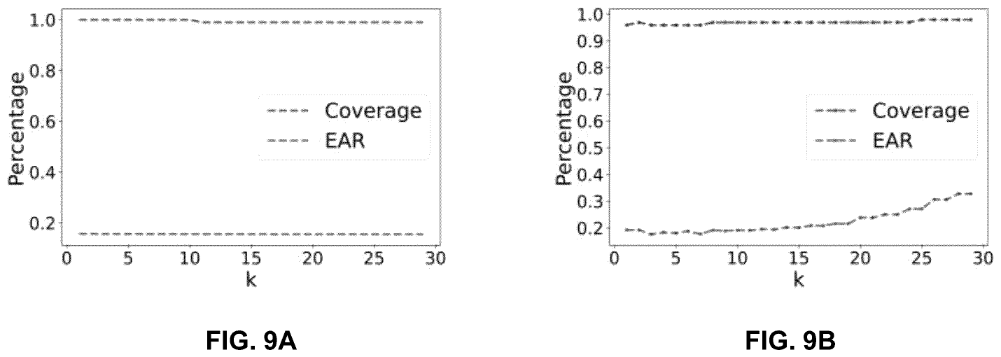

The example experiments further studied the effect of k (number of sBPP utilized in mBBP) along with the effects of random permutation. In this ablation study, the error level is fixed at α=0.1 and used table linking for demonstration. A similar trend can also be observed for column linking. In FIGS. 9A and 9B, the coverage and EAR curves are plotted for different values of k. Two approaches were considered, majority vote in FIG. 9B and random permutation in FIG. 9A, to aggregate the results of each sBPP. As demonstrated, both aggregation approaches achieve near-constant coverage across different k values. However, the EAR in random permutation remains constant for any k, while the EAR for majority vote tends to fluctuate when k is small and increases when k is large. This indicates the performance of majority vote is highly vulnerable to noisy sBPP which has a lower AUC score during the evaluation. In contrast, random permutation is more robust against noisy sBPP, and the choice of k does not significantly affect the final performance.

The example experiments illustrate that the present embodiments provide a reliable text-to-SQL approach, which includes schema linking to autonomously detect potential errors. Branching point prediction utilizes conformal prediction techniques on the hidden layers of LLM for schema linking to provide probabilistic guarantees. With respect to commonly used benchmarks, the example experiments validated the effectiveness of the present embodiments, demonstrating significant improvements in robustness and reliability.

Although the invention has been described with reference to certain specific embodiments, various modifications thereof will be apparent to those skilled in the art without departing from the spirit and scope of the invention as outlined in the claims appended hereto.

1. A computer-implemented method for conversion of natural language text to a structured query language query, the method comprising:
receiving a natural language question;
linking schema to the received natural language question using a machine learning model, wherein generation of the machine learning model comprises:
determining or predicting one or more branching points each representing deviations of generated tokens from ground truth; and
performing a corrective action to replace generated tokens at the branching points;
generating a structured query language query using a trained large language model, the large language model taking as input the natural language question and the schema linked to the received natural language question; and
outputting the structured query language query.

2. The method of claim 1, wherein the generated tokens comprise units of text representing strings of data of a database schema element.

3. The method of claim 1, wherein for determination of the one or more branching points, the ground truth comprises ground truth tokens, the ground truth tokens comprising a set of column and table names in the training data that are correct for given text queries in the training data.

4. The method of claim 3, wherein the corrective action comprises replacing the generated token with a corresponding correct ground truth token.

5. The method of claim 1, wherein prediction of the one or more branching points comprises predicting when each of the generated tokens deviate from a respective correct ground truth token.

6. The method of claim 5, wherein predicting when each of the generated tokens deviate from the respective correct ground truth token comprises using one or more classifier models, and wherein generation of the token comprises using the results of the one or more classifier models to quantify the probability that the generated token is a branching point.

7. The method of claim 6, wherein the one or more classifier models are provided for each hidden state of the machine learning model.

8. The method of claim 7, wherein each classifier model is trained using a training set of hidden state vectors for each generated token in the training set and a corresponding set of boolean variables indicating a ground truth value of whether such token corresponds to a branching point.

9. The method of claim 1, wherein generation of the machine learning model further comprises ceasing generation of the model and performing self-correction or soliciting human intervention using table trace back, the table trace back determines a difference between a decoder function computed on a sequence of tokens before and after the branching point.

10. The method of claim 9, wherein the corrective action comprises using a surrogate model to confirm relevance of the tables determined from the table trace back to the structured query language query.

11. A system for conversion of natural language text to a structured query language query, the system comprising one or more processing units and a data memory, the data memory comprising instructions for the one or more processing units to execute:
an input module to receive a natural language question;
a schema module to link schema to the received natural language question using a machine learning model, wherein generation of the machine learning model comprises:
determining or predicting one or more branching points each representing deviations of generated tokens from ground truth; and
performing a corrective action to replace generated tokens at the branching points;
a translation module to generate a structured query language query using a trained large language model, the large language model taking as input the natural language question and the schema linked to the received natural language question; and
an output module to output the structured query language query.

12. The system of claim 11, wherein the generated tokens comprise units of text representing strings of data of a database schema element.

13. The system of claim 11, wherein for determination of the one or more branching points, the ground truth comprises ground truth tokens, the ground truth tokens comprising a set of column and table names in the training data that are correct for given text queries in the training data.

14. The system of claim 13, wherein the corrective action comprises replacing the generated token with a corresponding correct ground truth token.

15. The system of claim 11, wherein prediction of the one or more branching points by the schema module comprises predicting when each of the generated tokens deviate from a respective correct ground truth token.

16. The system of claim 15, wherein predicting when each of the generated tokens deviate from the respective correct ground truth token comprises using one or more classifier models, and wherein generation of the token comprises using the results of the one or more classifier models to quantify the probability that the generated token is a branching point.

17. The system of claim 16, wherein the one or more classifier models are provided for each hidden state of the machine learning model.

18. The system of claim 17, wherein each classifier model is trained using a training set of hidden state vectors for each generated token in the training set and a corresponding set of boolean variables indicating a ground truth value of whether such token corresponds to a branching point.

19. The system of claim 11, wherein generation of the machine learning model by the schema module further comprises ceasing generation of the model and performing self-correction or soliciting human intervention using table trace back, the table trace back determines a difference between a decoder function computed on a sequence of tokens before and after the branching point.

20. Non-transitory computer-readable medium storing instructions that, when executed by one or more processing units, cause the one or more processing units to perform operations comprising:
receiving a natural language question;
linking schema to the received natural language question using a machine learning model, wherein generation of the machine learning model comprises:
determining or predicting one or more branching points each representing deviations of generated tokens from ground truth; and
performing a corrective action to replace generated tokens at the branching points;
generating a structured query language query using a trained large language model, the large language model taking as input the natural language question and the schema linked to the received natural language question; and
outputting the structured query language query.
